(19) United States
(12) Patent Application Publication
(10) Pub. No.: US 2007/0197319 A1
(43) Pub. Date: Aug. 23, 2007

(54) Method and apparatus for grinding a conical disk array, and a conical disk array

(75) Inventors: Martin Vornehm, Buhl (DE); Andreas Triller, Buhl (DE); Ronald Glas, Achern (DE); Markus Baumann, Karlsdorf-Neuthard (DE); Anton Simonov, Buhl (DE)

Correspondence Address: ALFRED J MANGELS, 4729 CORNELL ROAD, CINCINNATI, OH, 452412433, US

(73) Assignee: Luk Lamellen und Kupplungsbau Beteiligungs KG, Buhl (DE)

(21) Appl. No.: 11/645,136

(22) Filed: Dec. 23, 2006

Related U.S. Application Data
(60) Provisional application No. 60/753,785, filed on Dec. 23, 2005.

(51) Int. Cl. F16H 55/56

(52) U.S. Cl. 474/8

(57) ABSTRACT

A conical disk array for a belt-driven transmission having sets of conical friction disks on the input and output sides that are operatively coupled to each other by an endless torque-transmitting means to transmit torque. At least one friction disk of the conical friction disk sets has a friction surface structure with ground grooves that are not coaxial with each other. A grinding device for grinding the friction surface has its axis of rotation skewed relative to the axis of rotation of the friction disk being ground. A method is for producing a friction surface structure on a friction disk of a conical disk array with a grinding device with which the rotating friction disk serves to form a non-coaxially-oriented friction surface pattern as the friction surface.

### BACKGROUND OF THE INVENTION

1. Field of the Invention

The present invention relates to a conical disk array for a belt-driven transmission, in particular a CVT transmission, having a set of conical friction disks on the input side and a set of conical friction disks on the power take-off side, and which are coupled to each other by an endless torque-transmitting means to transmit torque. Furthermore, the present invention relates to a grinding device for grinding a friction surface structure of a friction disk of a conical disk array having at least one driven friction disk. In addition, the present invention also relates to a method for producing a friction surface structure of a friction disk of a conical disk array.

2. Description of the Related Art

Automatic transmissions in the form of belt-driven conical-pulley transmissions are sufficiently known in the field of automotive engineering. Continuously variable transmissions of that type have a variable speed drive unit, which usually includes a conical disk array that includes a set of conical friction disks on the input side and a set of conical friction disks on the power take-off side. The disks are coupled to each other by an endless torque-transmitting means, for example a plate-link chain, to transmit torque.

The endless torque-transmitting means running between the friction disk sets is pressed against a fixed friction disk of a friction disk set by a movable friction disk, in order to enable the transmission of torque. Moving the movable friction disk axially relative to the fixed friction disk changes the running radius of the endless torque-transmitting means, so that the transmission ratio in the belt-driven transmission is continuously variable.

The friction disks have a friction disk surface on their sides facing the endless torque-transmitting means. The friction disk surface has a specific friction surface structure, or a ground texture with ground grooves. The ground grooves run coaxially to each other. It has been found that with such a friction disk surface on the friction disk sets, an approximately constant coefficient of friction is produced between the friction disk surface and the endless torque-transmitting means, which reduces the life of the components and degrades the efficiency of the belt-driven transmission.

An object of the present invention is to provide a conical disk array for a belt-driven transmission of the type identified at the outset, with which the service life of the transmission can be extended and the efficiency can be improved.

### SUMMARY OF THE INVENTION

The object is achieved in accordance with the invention with a conical disk array for a belt-driven transmission, in particular for a CVT transmission, having a set of conical friction disks on the input side and a set of conical friction disks on the power take-off side that are coupled to each other by an endless torque-transmitting means to transmit torque. At least one friction disk of the conical friction disk sets has a friction surface structure with ground grooves that are not coaxial to each other. In that way a directional, non-coaxial friction surface structure is provided, through which different coefficients of friction act on the chain pin of a plate-link chain of the endless torque-transmitting means as it runs through the conical friction disk set, depending upon the current direction of slippage. Thus, a constant coefficient of friction is not achieved in the direction of slippage. The result is that the force pattern is harmonized, causing the peaks of force and of friction power to be reduced, in particular at the exit from the conical friction disk set. As a result, the wear resistance of the conical disk array is increased overall and the power loss at the frictional contact between the friction disks and the endless torque-transmitting means is reduced. Through reduction in power loss, the overall efficiency of the belt-driven transmission is further increased.

In an advantageous embodiment of the present invention, provision can be made for the ground grooves on the friction disk surface of each friction disk to run at an angle of from about 30° to about 60°, relative to the radial direction of the disk. Other angles or orientations of the ground grooves are also possible. The indicated angular range has, however, proven to be especially advantageous.

In accordance with an especially preferred embodiment of the present invention, provision can be made for the ground grooves of the friction surface structure of each friction disk to have an approximately spiral form, or the like. That form has proven to be especially advantageous, since with that friction surface structure the pressure requirement for pressing the endless torque-transmitting means against the friction disk is reduced, and as a result the efficiency is increased, because the friction power is not only redistributed, but a reduction of the losses can be achieved. In particular, an angle of inclination of the pattern of the ground grooves of about 45° can be especially advantageous.

The friction disks of the conical disk array in accordance with the invention can preferably have a friction surface structure with the ground grooves having a somewhat wavy or trench-like pattern in cross section. With that provided pattern relating to the depth of grinding, ridge crests and valleys can be formed along the friction surface structure, which provide the different coefficients of friction on the friction surface. At the same time, that brings about a relatively low coefficient of friction transverse to the individual ground grooves, since lubricant is carried along from the individual valleys to the ridge crests during contact between the endless torque-transmitting means and the friction surface structure. A relatively high coefficient of friction will result along a ground groove, i.e., along a ridge crest, since mixed friction occurs there.

Because the friction surface structure on the friction disks of the conical disk array in accordance with the invention has a trench-like or undulating structure when viewed in cross section, which is neither purely circumferential nor purely radial in its orientation, the result is the advantageous harmonization of the force pattern because of the formation of different coefficients of friction depending upon the current direction of slippage. Other friction surface structures on the friction disks are also conceivable.

The object of the invention is also achieved by a grinding device for grinding friction surface structures of friction disks of a conical disk array by at least one driven grinding wheel, wherein the axis of rotation of the grinding wheel and the axis of rotation of the friction disk to be ground are skewed in their orientation to each other.

Because of that skewed orientation between the axes of rotation of the grinding wheel and the friction disk to be machined, the result is the previously described and especially advantageous friction surface structure on the respective machined friction disks of the conical disk array. Because of the skewed orientation of the axes of rotation there is no point of intersection of the axes of rotation, but only a minimal separation.

The arrangement possibilities are many and varied. For example, it can be provided that the axis of rotation of the grinding wheel is situated ahead of the friction disk to be ground, in the axial direction. It is also possible for the grinding wheel to be situated behind the friction disk to be machined, in the axial direction. It is also possible to achieve other arrangement options with the skewed alignment of the two axes of rotation, in order to further optimize the production or grinding of the friction surfaces on the friction disks.

With the grinding device in accordance with the invention, a preferred embodiment can provide a specially designed grinding wheel surface of the grinding wheel in coordination with the skewed arrangement. It has been found that an angle between the inclined grinding wheel surface and the ground surface of the grinding wheel should be about 10° to 30°, for example. Other angles of inclination of the grinding wheel surface are also possible.

Finally, the object of the invention is also achieved by a method for producing a friction surface structure of a friction disk of a conical disk array with a grinding device with which a rotating friction disk is machined by a rotating grinding wheel in such a way that a non-coaxially-oriented friction surface structure is formed as the friction surface. Thus, exactly the previously described, especially advantageous friction surface structure can be produced on the respective friction disks of the conical disk array for a belt-driven transmission, by the method proposed in accordance with the invention.

Preferably, the method is carried out with the grinding device already described. However, other grinding devices can also be employed to carry out the procedure. Within the framework of an advantageous embodiment of the method in accordance with the invention, provision can be made for the friction disk being machined and the grinding wheel to each be rotated at different speeds to achieve the desired friction surface structure. In particular, the difference in speed of rotation between the friction disk being machined and the grinding wheel results in the particular patterns of the ground grooves along the friction surface structure.

### BRIEF DESCRIPTION OF THE DRAWINGS

The structure, operation, and advantages of the present invention will become further apparent upon consideration of the following description, taken in conjunction with the accompanying drawings in which:

FIG. 1 is a front perspective view of a friction disk of a conical disk array;

FIG. 2 is a perspective view of the friction disk of FIG. 1 with an endless torque-transmitting means in operative position;

FIGS. 3a through 3d each show a sector X of the friction surface structure of the friction disk in accordance with FIG. 2;

FIG. 4 is a schematic view of an embodiment of a grinding device in accordance with the invention for grinding the surface structure of a friction disk;

FIG. 5 is a schematic view of another embodiment of a grinding device in accordance with the invention;

FIG. 6 is an enlarged cross-sectional view of a grinding wheel in operative position against a friction disk; and

FIG. 7 is an enlarged, fragmentary perspective view of the friction surface structure of the friction disk.

### DESCRIPTION OF THE PREFERRED EMBODIMENTS

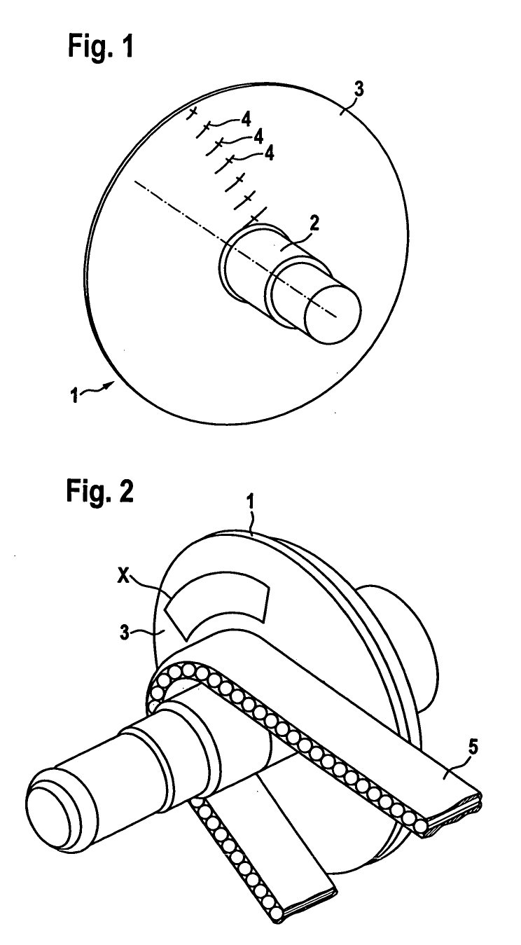

FIG. 1 shows an embodiment of a friction disk 1 as a fixed disk of a conical disk array in accordance with the invention, for use in connection with a belt-driven transmission (not shown), in particular a CVT transmission.

Friction disk 1 of the conical friction disk set is mounted by means of a conical disk set shaft 2. Because of the decreasing thickness of friction disk 1 in the outward radial direction, various transmission ratios can be achieved by changing the running radius of the endless torque-transmitting means. The endless torque-transmitting means, not further shown, is in contact with the friction surface 3 of friction disk 1 in order to achieve a desired transfer of torque from the drive side to the power take-off side in the belt-driven transmission.

The friction surface structure of friction disk 1 is machined in such a way that ground grooves 4, which are only schematically shown, have an approximately spiral form. Because of that non-coaxially-oriented pattern of the individual ground grooves 4, different coefficients of friction act on the chain pin of the endless torque-transmitting means, which is in the form of a plate-link chain, as it runs through the conical friction disk set, depending upon the current direction of slippage, whereby a harmonized pattern of force is achieved between plate-link chain 5 and the friction surface structure on friction disk 1 of the conical disk set. Because of those different coefficients of friction, peaks of force and friction power are reduced on the entire conical friction disk set, so that the service life of the conical disk array in accordance with the invention is increased.

In addition, the design of the friction surface structure of each friction disk 1 in accordance with the invention reduces the clamping requirement of each conical disk set, thereby increasing the overall efficiency of the belt-driven transmission.

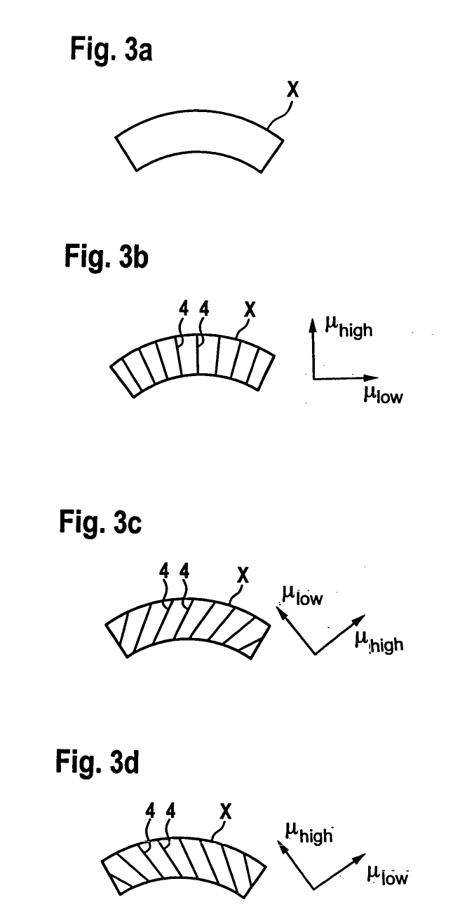

FIG. 2 shows a three-dimensional detail view of friction disk 1 with plate-link chain 5 in position. As an example, a sector X from the friction surface structure 3 of friction disk 1 is identified. That sector X is shown again in FIGS. 3a through 3d with different friction surface structures.

FIG. 3a shows sector X of friction disk 1 with one form of friction surface structure, which is an isotropic surface structure, i.e., a surface structure having the same friction coefficient in all directions.

FIG. 3b shows another form of friction surface structure that has ground grooves 4 running exclusively radially. The diagram to the right of FIG. 3b shows the directionally dependent coefficient of friction μ. In accordance with the diagram, there is a high coefficient of friction μ_{high} in the direction of the ground grooves 4, i.e., in the radial direction, and a relatively low coefficient of friction μ_{low} at an oblique angle to the ground grooves 4.

FIG. 3c shows sector X of another embodiment of a friction surface structure with ground grooves 4, in which the ground grooves 4 run at an angle of about 45° to the radial direction. That figure also includes a diagram showing the direction-dependent coefficient of friction. With that friction surface structure there is again a high coefficient of friction μ_{high} along the ground grooves 4 and a low coefficient of friction μ_{low} at an oblique angle to the ground grooves 4.

Finally, FIG. 3d shows a further embodiment of a friction surface structure of friction disk 1, also with ground grooves 4 running at 45° to the radial direction, but inclined in the other direction. In contrast to the friction surface structure in accordance with FIG. 3c, the result is a diagram with the coefficients of friction μ_{high} and μ_{low} reversed, because of the different direction of inclination of the ground grooves 4.

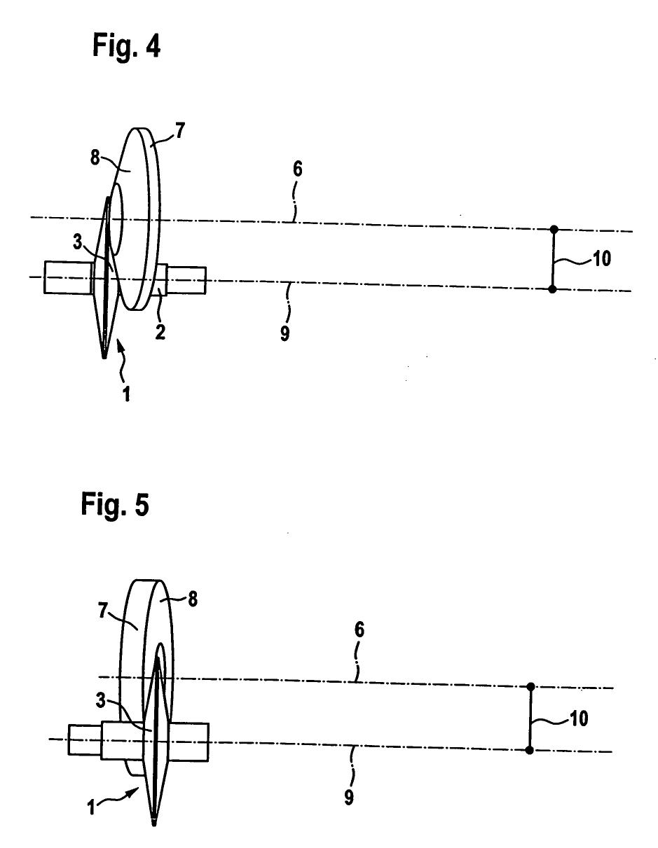

FIG. 4 shows a schematic setup of an embodiment of a grinding device in accordance with the invention for producing or grinding a friction disk surface 3 of friction disk 1 of the conical disk array in accordance with the invention. The grinding device in accordance with the invention has a grinding wheel 7 that rotates about an axis of rotation 6 and includes a grinding wheel surface 8. Friction surface 3 of friction disk 1 is machined by grinding wheel surface 8 of grinding disk 7.

What is special about the grinding device in accordance with the invention is that the axis of rotation 6 of grinding wheel 7 and the axis of rotation 9 of conical disk set shaft 2 are skewed in their orientation to each other. As a result, there is no point of intersection between the axes of rotation 6 and 9. Merely a minimal separation 10 is achieved, which is indicated in FIG. 4. In the embodiment shown in FIG. 4, the axis of rotation 6 of grinding wheel 7 is shown at a perspective slant, namely in front of the drawing plane in the area of grinding wheel 7 and behind the drawing plane in the area of the free end of axis of rotation 6. Axis of rotation 9 of conical friction disk set shaft 2 lies in the drawing plane in the embodiment shown in FIG. 4.

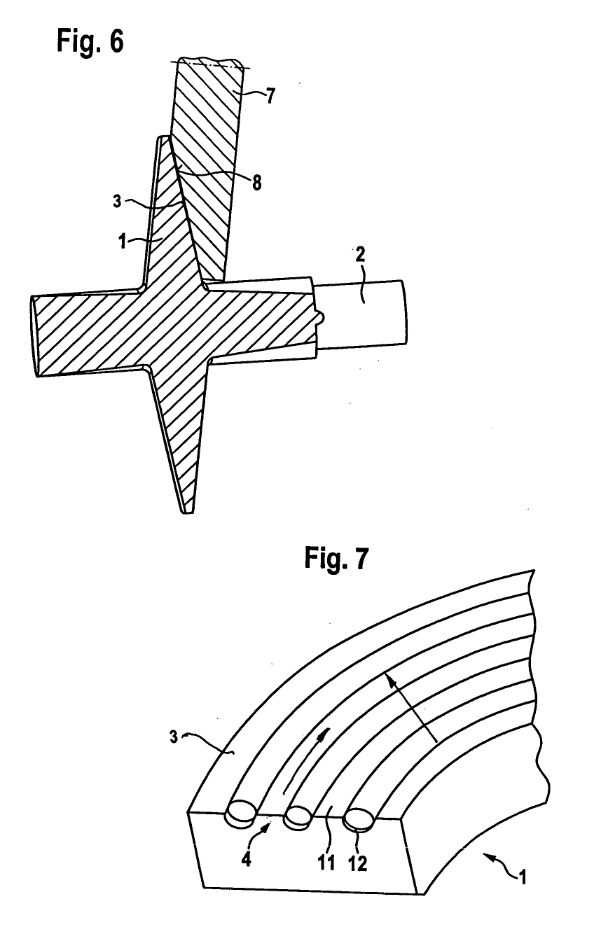

FIG. 5 shows another arrangement of the grinding device in accordance with the invention. In contrast to the embodiment shown in FIG. 4, in this embodiment the axis of rotation 6 of grinding wheel 7 is situated behind the drawing plane in the area of grinding wheel 7 and in front of the drawing plane at the free end of axis of rotation 6. Axis of rotation 9 of the conical friction disk set again lies in the drawing plane.

FIG. 6 shows an enlarged cross-sectional view of friction disk 1 with a grinding wheel 7 intended for working against the friction surface 3. The cross section of grinding wheel 7 illustrates the inclined grinding wheel surface 8. In that embodiment, grinding surface 8 of grinding wheel 7 is inclined at a predetermined angle. The angle between grinding wheel surface 8 and the disk surface is about 20°. In this figure the conical disk set is inclined relative to friction disk 1 so that the axis of rotation of the conical friction disk set does not lie in the drawing plane in that figure. The shape of grinding surface 8 of grinding wheel 7 does not represent the simple 2-D counterpart to friction surface 3 of friction disk 1.

FIG. 7 shows an enlarged fragmentary view of friction disk surface 3 with a wavy friction surface structure of friction disk 1. The wavy or corrugation-like design of the ground grooves 4 in cross section is clarified by that figure. The respective direction-independent coefficient of friction is indicated by arrows. Mixed friction occurs along the ridge crests 11 of the ground grooves 4, so that the coefficient of friction μ along those ridge crests 11 has a constant high value μ_{high}. In contrast, a relatively low coefficient of friction μ_{low} results at oblique angles to the ground grooves 4. That is the result of the fact that lubricant is carried along from the valleys 12 to the ridge crests 11. In that illustration of the friction surface structure of friction disk 1 a coaxial arrangement of the ground grooves 4 is represented for the sake of simplicity.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A conical disk array for a belt-driven transmission having a set of conical friction disks on the input side and a set of conical friction disks on the power take-off side, which disk sets are coupled to each other by an endless torque-transmitting means to transmit torque, said disk array comprising: at least one friction disk of the conical friction disk sets has a conical friction disk surface for engagement with the endless torque-transmitting means, wherein the conical friction disk surface includes a plurality of ground grooves that are not coaxial relative to each other.

2. A conical disk array in accordance with claim 1, wherein the ground grooves of the conical friction disk surface extend at an angle of from about 30° to about 60° relative to a radial direction of the conical friction disk surface.

3. A conical disk array in accordance with claim 1, wherein the ground grooves of the conical friction disk surface have a substantially spiral shape relative to an axis of rotation of the conical disk array.

4. A conical disk array in accordance with claim 1, wherein the ground grooves of the conical friction disk surface define a wavy cross-sectional form.

5. A grinding device for grinding a conical friction disk surface of a friction disk of a rotatable conical disk array, said grinding device comprising: at least one rotationally driven grinding wheel, wherein the axis of rotation of the grinding wheel and the axis of rotation of the friction disk being ground are skewed in their orientation relative to each other so that the axes of rotation do not intersect.

6. A grinding device in accordance with claim 5, wherein the grinding wheel has a conical grinding surface facing the friction disk being ground.

7. A grinding device in accordance with claim 5, wherein the grinding wheel has parallel front and back grinding surfaces, and one of the grinding surfaces faces the friction disk being ground.

8. A grinding device in accordance with claim 5, wherein the grinding disk has a grinding surface that is inclined at a predetermined angle relative to the friction disk conical surface.

9. A grinding device in accordance with claim 8, wherein the angle between the inclined grinding wheel surface and the friction disk surface being ground is from about 10° to about 30°.

10. A method for producing a friction surface structure of a friction disk of a conical disk array, said method comprising the steps of: providing a conical disk having a friction surface for frictional engagement with an endless torque-transmitting means; forming grooves on the friction surface of the conical disk by rotating the conical disk and contacting the rotating friction surface with a rotating grinding wheel, whereby a non-coaxially-oriented friction surface structure is formed as the friction disk surface.

11. A method in accordance with claim 10, including the step of rotating the friction disk to be ground and the grinding wheel at different rotational speeds.
